(19) United States
(12) Patent Application Publication
(10) Pub. No.: US 2025/0147186 A1
(43) Pub. Date: May 8, 2025

(54) OPERATION MAP CONSTRUCTION METHOD AND APPARATUS, MOWING ROBOT, AND STORAGE MEDIUM

(71) Applicant: SHENZHEN MAMMOTION INNOVATION CO., LIMITED, Shenzhen (CN)

(72) Inventors: Ning WANG, Shenzhen (CN); Pengju DU, Shenzhen (CN); Zhenhao HUANG, Shenzhen (CN)

(73) Assignee: SHENZHEN MAMMOTION INNOVATION CO., LIMITED, Shenzhen (CN)

(21) Appl. No.: 19/011,872

(22) Filed: Jan. 7, 2025

Related U.S. Application Data
(63) Continuation of application No. PCT/CN2023/105187, filed on Jun. 30, 2023.

(30) Foreign Application Priority Data
Jul. 8, 2022 (CN) 202210806394.4

(51) Int. Cl. G01S 17/89; A01D 34/00; A01D 101/00; G06T 7/73; G06V 10/764; G06V 20/58; G06V 20/70

(52) U.S. Cl. CPC G01S 17/89; A01D 34/008; G06T 7/73; G06V 10/764; G06V 20/58; G06V 20/70; A01D 2101/00; G06T 2207/10028; G06T 2207/30261

(57) ABSTRACT

An operation map construction method disclosed in embodiments of the present disclosure may include: acquiring laser point cloud data in an environment corresponding to a target map; determining candidate obstacles in the target map based on the laser point cloud data; obtaining feature images of the candidate obstacles and determining a target obstacle from the candidate obstacles based on the feature images; and delineating an operational area and a non-operational area in the target map based on the target obstacle.

### CROSS-REFERENCE TO RELATED APPLICATIONS

The present application is a continuation application of International Application No. PCT/CN2023/105187, filed Jun. 30, 2023, which claims priority to Chinese Patent Application No. CN202210806394.4, filed with the China National Intellectual Property Administration on Jul. 8, 2022 and entitled “OPERATION MAP CONSTRUCTION METHOD AND APPARATUS, MOWING ROBOT, AND STORAGE MEDIUM”, the disclosures of which are incorporated herein by reference in their entireties.

### TECHNICAL FIELD

The present disclosure relates to the field of computer technologies, and in particular, to an operation map construction method and apparatus, a mowing robot, and a storage medium.

### BACKGROUND

Mowing robots are widely used for maintenance of home courtyard lawns and trimming of large grass areas. A mowing robot integrates technologies such as motion control, multi-sensor fusion, route planning, etc. In order to control the mowing robot to implement a mowing operation, a mowing route needs to be planned for the mowing robot, so that the mowing robot can completely cover all operational areas.

When the mowing robot mows a lawn in a new environment, a staff member needs to detect the site in real time and transmit data to the mowing robot, so as to create an electronic map for the mowing robot to use. For different lawns, measurement and input need to be performed again, i.e., the current operation map construction is inefficient.

### SUMMARY

Embodiments of the present disclosure provide an operation map construction method and apparatus, a mowing robot, and a storage medium, which can improve the operation map construction efficiency.

According to a first aspect, an embodiment of the present disclosure provides an operation map construction method, including:
obtaining a preset mowing area;
acquiring laser point cloud data in an environment corresponding to a target map;
determining candidate obstacles in the target map based on the laser point cloud data;
obtaining feature images of the candidate obstacles and determining a target obstacle from the candidate obstacles based on the feature images; and
delineating an operational area and a non-operational area in the target map based on the target obstacle.

According to a second aspect, an embodiment of the present disclosure provides an operation map construction apparatus, including:
an acquisition module configured to acquire laser point cloud data of a target map;
a first determining module configured to determine candidate obstacles in the target map based on the laser point cloud data;
an obtaining module configured to obtain feature images of the candidate obstacles;
a second determining unit configured to determine a target obstacle from the candidate obstacles based on the feature images; and
a delineation unit configured to delineate an operational area and a non-operational area in the target map based on the target obstacle.

### BRIEF DESCRIPTION OF THE DRAWINGS

In order to more clearly describe the technical solutions in the embodiments of the present application, the accompanying drawings required for describing the embodiments will be briefly described below. Apparently, the accompanying drawings in the following description show merely some of the embodiments of the present application, and those skilled in the art may still derive other drawings from these accompanying drawings without creative efforts.

FIG. 1A is a schematic diagram of a scene of an operation map construction method according to an embodiment of the present application;

FIG. 1B is a schematic flowchart of an operation map construction method according to an embodiment of the present application;

FIG. 2A is a schematic diagram of a structure of an operation map construction apparatus according to an embodiment of the present application;

FIG. 2B is a schematic diagram of another structure of an operation map construction apparatus according to an embodiment of the present disclosure; and

FIG. 3 is a schematic diagram of a structure of an electronic device according to an embodiment of the present disclosure.

### DETAILED DESCRIPTION OF EMBODIMENTS

The technical solutions in the embodiments of the present disclosure will be described clearly and completely below with reference to the accompanying drawings in the embodiments of the present disclosure. Apparently, the described embodiments are merely some rather than all of the embodiments of the present disclosure. All the other embodiments obtained by those skilled in the art based on the embodiments of the present disclosure without creative efforts shall fall within the scope of protection of the present disclosure.

It should be noted that when an element is referred to as being “fixed to” or “disposed” on another element, it may be directly on or indirectly on another element. When an element is referred to as being “connected” to another element, it may be directly or indirectly connected to another element.

In addition, the connection may have the function of fixing or circuit connection.

It should be understood that orientations or positional relationships indicated by the terms “length”, “width”, “upper”, “lower”, “front”, “rear”, “left”, “right”, “vertical”, “horizontal”, “top”, “bottom”, “inner”, “outer”, etc. are orientations or positional relationships shown in the accompanying drawings, and are merely for facilitating the description of the embodiments of the present disclosure and simplifying the description, rather than indicating or implying that a specified apparatus or element must have a specific orientation or be constructed and operated in a specific orientation, and therefore should not be construed as limiting the present disclosure.

In addition, the terms “first” and “second” are merely used for the purpose of illustration, and cannot be construed as indicating or implying relative importance or implicitly indicating the number of technical features indicated. Thus, the features defined with “first” and “second” may explicitly or implicitly include one or more features. In the description of the embodiments of the present disclosure, “a plurality of” means two or more, unless specifically defined otherwise.

The embodiments of the present disclosure provide an operation map construction method and apparatus, a mowing robot, and a storage medium.

The operation map construction apparatus may be specifically integrated in a microcontroller unit (MCU) of a mowing robot, or may be integrated in an intelligent terminal or a server. The MCU, also referred to as a single-chip microcomputer, is a chip-level computer formed through appropriate reduction of a frequency and specifications of a central processing unit (CPU), and interfacing of peripherals such as a memory, a timer, a USB, an analog-to-digital converter/a digital-to-analog converter, a UART, a PLC, and a DMA, to provide different combined control for different disclosure scenarios. The mowing robot may move automatically, prevent collisions, and automatically return within a range for charging, is provided with safety detection and battery level detection, has a certain climbing ability, and therefore is particularly suitable for lawn trimming and maintenance in places such as home courtyards, public green space, etc. The mowing robot has the characteristics of automatic mowing, grass clipping cleanup, automatic rain avoidance, automatic charging, automatic obstacle avoidance, compact size, electronic virtual fencing, network control, etc.

The terminal may be a smartphone, a tablet computer, a laptop, a desktop computer, a smart speaker, a smart watch, etc., but is not limited thereto. The terminal and the server may be connected directly or indirectly by means of wired or wireless communication, and the server may be a separate physical server, a server cluster or distributed system including a plurality of physical servers, or a cloud server which provides cloud services, cloud databases, cloud computing, cloud functions, cloud storage, network services, cloud communication, middleware services, domain name services, security services, CDNs, and basic cloud computing services such as big data and artificial intelligence platforms, which is not limited in the present disclosure.

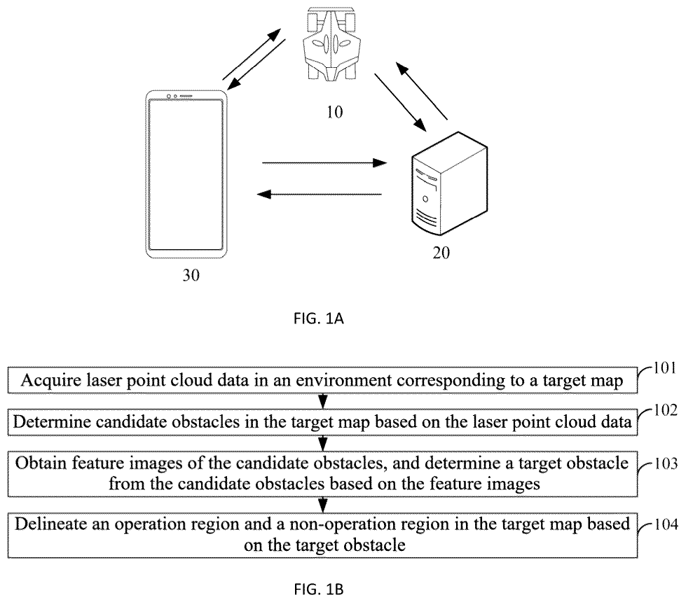

For example, referring to FIG. 1A, the present disclosure provides a mowing system, including a mowing robot 10, a server 20, and user device 30 which are in communication connections with one another. The mowing robot 10 is provided with a lidar, and may acquire laser point cloud data in an environment corresponding to a target map through the lidar. Then, the mowing robot 10 may determine candidate obstacles in the target map based on the laser point cloud data, where the target map may be an environmental map or an electronic map. Next, a camera in the mowing robot 10 obtains feature images of the candidate obstacles, and a target obstacle is determined from the candidate obstacles based on the feature images. Finally, the mowing robot 10 delineates an operational area and a non-operational area in the target map based on the target obstacle. After delineating the operational area and the non-operational area, the mowing robot 10 may synchronize data of the operational area and data of the non-operational area to the server 20 and the user device 30, to facilitate subsequent monitoring of a mowing operation of the mowing robot 10. In the mowing solution provided in the present disclosure, the candidate obstacles are determined in the target map based on the laser point cloud data; then, the target obstacle is determined based on the feature images of the candidate obstacles; and finally, the operational area and the non-operational area are delineated in the target map based on the target obstacle. That is, through the combination of an image vision technology and a laser point cloud technology, the problem of delineation omission or error caused by manual delineation of the operational area and the non-operational area can be avoided. In addition, due to the unified scanning of an operation environment by the lidar, positions of all obstacles can be determined at one time without the need to delineate the obstacles one by one, thereby avoiding the problems of a low overall delineation speed and low map construction efficiency caused by the large volume of obstacles. In this way, this solution improves the operation map construction efficiency.

Detailed descriptions are provided below. It should be note that the order of description of the following embodiments does not constitute a limitation on the order of precedence for the embodiments.

An operation map construction method comprising: acquiring laser point cloud data in an environment corresponding to a target map; determining candidate obstacles in the target map based on the laser point cloud data; obtaining feature images of the candidate obstacles and identifying a target obstacle from the candidate obstacles based on the feature images; and delineating an operational area and a non-operational area in the target map based on the target obstacle.

Referring to FIG. 1B, FIG. 1B illustrates a schematic flowchart of an operation map construction method according to an embodiment of the present disclosure. A specific process of the operation map construction method may be as follows:

101: Acquiring laser point cloud data in an environment corresponding to a target map.

The target map is a mowing map corresponding to a mowing robot, the mowing robot may perform a mowing operation in an area corresponding to the target map, and subsequently may delineate an operational area and a non-operational area in the target map. The target map does not include buildings such as houses where the operation cannot be performed.

For example, specifically, the body of the mowing robot may be provided with a three-dimensional lidar. The three-dimensional lidar is a measuring instrument that instantaneously measures three-dimensional spatial coordinate values according to a laser ranging principle (including a pulse laser and a phase laser). A three-dimensional visualization model of a complex and irregular scene may be quickly established based on spatial point cloud data obtained by using a three-dimensional laser scanning technology.

In actual disclosure, the three-dimensional lidar obtains pose information and three-dimensional point clouds corresponding to acquisition points based on a simultaneous localization and mapping (SLAM) method. The three-dimensional lidar may be a handheld, backpack-mounted, or vehicle-mounted mobile data acquisition device for mobile scanning.

For example, a point cloud coordinate system is constructed using an acquisition point of initial collection of the three-dimensional lidar as a coordinate origin, where the initial acquisition here is the acquisition of a first frame of three-dimensional point cloud corresponding to a three-dimensional point cloud map by the three-dimensional lidar. The acquisition point may be a location of the center of gravity of the three-dimensional lidar, or a fixed reference point on the device, provided that requirements for establishing the coordinate system and defining the coordinate origin are met. In an example, in the point cloud coordinate system, the Z axis is in a vertical scanning plane, with the upward direction being positive, the X and Y axes are both in a transverse scanning plane, and the three axes are perpendicular to each other to form a left-handed coordinate system. During mobile scanning, a real-time pose of the three-dimensional lidar and a three-dimensional point cloud at that time may be obtained in real time based on the SLAM method.

102: Determining candidate obstacles in the target map based on the laser point cloud data.

Reflectivity is a key characteristic of a laser sensor, which may reflect the material properties of the environment. Therefore, the reflectivity can be used to identify candidate obstacles in the target map. That is, optionally, in some embodiments, the step of “determining candidate obstacles in the target map based on the laser point cloud data” may specifically include:
(11) obtaining a map coordinate system of the target map;
(12) extracting a reflection value and three-dimensional coordinates corresponding to each three-dimensional laser point from the laser point cloud data; and
(13) determining the candidate obstacles in the target map based on the map coordinates, and the reflection value and the three-dimensional coordinates corresponding to the three-dimensional laser point.

For example, a corresponding pixel value may be rendered in the target map based on the reflection value corresponding to each three-dimensional laser point. For example, a three-dimensional laser point with a reflection value of a corresponds to a pixel value of 10, and a three-dimensional laser point with a reflection value of b corresponds to a pixel value of 45, which may be specifically set based on an actual situation and will not be repeated herein.

The coordinate system of the target map is a two-dimensional coordinate system, while the coordinates of the three-dimensional laser point further include height information, and a point cloud coordinate system corresponding to the laser point cloud data needs to be further obtained, to facilitate subsequent determining of the candidate obstacles in the target map. That is, alternatively, in some embodiments, the step of “determining the candidate obstacles in the target map based on the map coordinates, and the reflection value and the three-dimensional coordinates corresponding to the three-dimensional laser point” may specifically include:
(21) determining a point cloud coordinate system corresponding to the laser point cloud data;
(22) rendering the reflection value corresponding to the three-dimensional laser point to the target map based on the three-dimensional coordinates corresponding to the three-dimensional laser point and a transformation relationship between the map coordinate system and the point cloud coordinate system; and
(23) determining the candidate obstacles in the target map based on a pixel value in a rendered target map.

For example, specifically, the three-dimensional coordinates corresponding to the three-dimensional laser point may be transformed into map coordinates in the target map based on the transformation relationship between the map coordinate system and the point cloud coordinate system. Then, the reflection value corresponding to the three-dimensional laser point is rendered to the target map based on the map coordinates obtained through transformation. Finally, the candidate obstacles are determined in the target map based on the pixel value in the rendered target map.

Optionally, in some embodiments, the step of “rendering the reflection value corresponding to the three-dimensional laser point to the target map based on the three-dimensional coordinates corresponding to the three-dimensional laser point and a transformation relationship between the map coordinate system and the point cloud coordinate system” may specifically include:
(41) transforming the three-dimensional coordinates corresponding to the three-dimensional laser point based on the transformation relationship between the map coordinate system and the point cloud coordinate system, to obtain map coordinates of the three-dimensional laser point in the target map; and
(42) rendering the reflection value corresponding to the three-dimensional laser point to the target map based on the map coordinates of the three-dimensional laser point in the target map.

The three-dimensional coordinates corresponding to the three-dimensional laser point may be transformed according to a preset formula, where the preset formula represents a transformation relationship between a three-dimensional coordinate system and a two-dimensional coordinate system, i.e., the transformation relationship between the point cloud coordinate system and the map coordinate system. It should be noted that, in the image processing field, coordinate system transformation is performed to transform a three-dimensional spatial world coordinate system into a two-dimensional pixel coordinate system for image processing. Commonly used coordinate systems include a world coordinate system, a camera coordinate system, and an image coordinate system. The world coordinate system (xw, yw, zw), also referred to as a measurement coordinate system, is a three-dimensional rectangular coordinate system, based on which spatial positions of a camera and an object to be detected may be described. The camera coordinate system (xc, yc, zc) is also a three-dimensional rectangular coordinate system. The origin is at an optical center of a lens, the xc and yc axes are respectively parallel to two sides of an image plane, and the zc axis is an optical axis of the lens, which is perpendicular to the image plane. The image coordinate system (x, y) is a two-dimensional rectangular coordinate system on the image plane. The origin of the image coordinate system is an intersection point (also referred to as a principal point) of the optical axis of the lens and the image plane. The x axis of the image coordinate system is parallel to the xc axis of the camera coordinate system. The y axis of the image coordinate system is parallel to the yc axis of the camera coordinate system.

Specifically, a coordinate transformation relationship may be determined based on extrinsic parameters between a lidar device and an image acquisition device (i.e., a target map acquisition device) and intrinsic parameters of the image acquisition device. The extrinsic parameters are parameters of the image acquisition device in the world coordinate system, such as a position and a direction of rotation of the image acquisition device. The intrinsic parameters are parameters related to properties of the image acquisition device, such as a focal length and a pixel size of the image acquisition device.

For example, three-dimensional point cloud coordinates pij may be transformed into two-dimensional map coordinates p′i′j′ in the following manner:

$$\begin{matrix}{X}^{′} = ( x / z ) * fx + c x \\ {Y}^{′} = ( y / z ) * fy + c y\end{matrix}$$

where fx and fy are focal lengths of the image acquisition device, cx and cy are principal points of the image acquisition device, and two-dimensional map coordinates corresponding to the three-dimensional point cloud coordinates pij (x, y, z) are p′i′j′(x′, y′).

103: Obtain feature images of the candidate obstacles and determining a target obstacle from the candidate obstacles based on the feature images.

It should be noted that the candidate obstacles are determined based on the laser point cloud data, that is, the obstacles are determined based on the reflection of a lidar signal. However, the mowing robot is generally used for outdoor operation. If there are other partially light-transmitting substances between a scanner and an object to be detected, such as rain, snow and dust, which are common in outdoor environments, part of laser energy is reflected back early, and as long as a trigger threshold is reached, the partially light-transmitting substances may be considered as detected objects, leading to a measurement error. Therefore, the candidate obstacles determined based on the laser point cloud data may not be real obstacles. Therefore, in the present disclosure, the obstacles are positioned and identified by combining a vision technology and a point cloud technology.

For example, specifically, images of the candidate obstacles may be acquired and feature extraction may be performed on the acquired images, to obtain feature images of the candidate obstacles. Specifically, a convolutional neural network (CNN) may be used to perform feature extraction on the acquired images. Further, the convolutional neural network may be used to determine the target obstacle from the candidate obstacles. That is, optionally, in some embodiments, the step of “determining a target obstacle from the candidate obstacles based on the feature images” may specifically include:
(51) inputting the feature images into a preset image classification network, to obtain classification labels of the candidate obstacles; and
(52) determining a candidate obstacle whose classification label is a target label as the target obstacle.

The image classification network may be obtained through pre-training, and may specifically include the following.

Convolutional layer: mainly for performing feature extraction on an input image (such as a training sample or an image needing to be recognized), where a size of a convolution kernel and the number of convolution kernels may depend on the actual disclosure, for example, sizes of convolution kernels of first to fourth convolutional layers may be (7, 7), (5, 5), (3, 3), and (3, 3) in sequence. Optionally, in order to reduce the calculation complexity and improve the calculation efficiency, in this embodiment, the sizes of the convolution kernels of the four convolutional layers may all be set to (3, 3), an activation function is a “rectified linear unit (relu)”, and a padding (padding is a space between an element border and element content, which is defined by properties) manner is set to “same”. The “same” padding manner may be simply understood as padding an edge with zeros, and the number of zeros for padding on the left (top) is the same as or one less than the number of zeros for padding on the right (bottom). Optionally, the convolutional layers may be directly connected, thereby increasing a network convergence speed. In order to further reduce a calculation amount, a downsampling (pooling) operation may be performed on all or any one to two layers of the second to fourth convolutional layers. The downsampling operation is basically the same as a convolution operation, except that a convolution kernel for downsampling takes only the maximum value (max pooling) or average value (average pooling), etc. of the corresponding position. For ease of description, in the embodiments of the present disclosure, an example in which the downsampling operation is performed at both the second and third convolutional layers, and the downsampling operation is specifically max pooling is used for description.

It should be noted that, for ease of description, in the embodiments of the present disclosure, both a layer at which the activation function resides and a downsampling layer (also referred to as a pooling layer) are classified as convolutional layers. It should be understood that the structure may also be considered to include a convolutional layer, a layer at which the activation function resides, a downsampling layer (i.e., a pooling layer), and a fully connected layer. Certainly, the structure may further include an input layer for inputting data and an output layer for outputting data, which will not be repeated herein.

Fully connected layer: learned features may be mapped to a sample label space. The fully connected layer functions mainly as a “classifier” in the entire convolutional neural network. Each node of the fully connected layer is connected to all nodes of the output of a previous layer (such as the downsampling layer in the convolutional layers). One node of the fully connected layer is referred to as one neuron in the fully connected layer, and the number of neurons in the fully connected layer may depend on requirements in the actual disclosure. For example, in a text detection model, the number of neurons in the fully connected layer may be set to 512 or 128, and so on. Similar to the convolutional layer, optionally, in the fully connected layer, a nonlinear factor may also be added by adding an activation function, for example, adding an activation function sigmoid (an S-type function).

Specifically, the image classification network may be used to recognize the feature images, to obtain a probability that the candidate obstacle belongs to each type of obstacle, and a corresponding classification label is output based on the probability. Finally, a candidate obstacle whose classification label is a target label is determined as the target obstacle. For example, a candidate obstacle whose classification label is a flower bed is determined as the target obstacle. 104: Delineating an operational area and a non-operational area in the target map based on the target obstacle.

Specifically, contour information of the target obstacle may be obtained, and the operational area and the non-operational area may be delineated in the target map. For example, a curve surrounding the target obstacle is output. After the non-operational area is determined, the operational area is delineated in the target map based on a preset operation boundary and the non-operational area. That is, optionally, in some embodiments, the step of “delineating an operational area and a non-operational area in the target map based on the target obstacle” may specifically include:
(61) obtaining at least contour information of the target obstacle below a preset height;
(62) outputting, based on the contour information and a location of the target obstacle in the target map, an isolation curve surrounding the target obstacle; and
(63) determining an area enclosed by the isolation curve as the non-operational area and an area other than the non-operational area as the operational area.

Alternatively, the preset height may be set to be slightly higher than a height of the mowing robot. For example, if the height of the mowing robot is 30 centimeters, the preset height may be set to 35 centimeters, to ensure that the mowing robot will not be blocked by the obstacles and stop the mowing operation when performing the mowing operation.

It should be noted that when there are a plurality of target obstacles in the target map, distances between adjacent target obstacles may be calculated, and the target obstacles with distances therebetween less than a threshold may be grouped into the same non-operational area, where the threshold may be set based on a size of the mowing robot. This can avoid the problem that the mowing robot fails to operate due to the excessively small delineated operational area, and prevent this type of operational area from affecting the subsequent process of the mowing operation, thereby improving the subsequent mowing efficiency.

Further, in some embodiments, the operational area and the non-operational area may be distinguished by different colors. That is, optionally, after the step of “delineating an operational area and a non-operational area in the target map based on the target obstacle”, the method may specifically further include:
highlighting the operational area using a first color and highlighting the non-operational area using a second color.

For example, specifically, the first color may be yellow and the second color may be red, which may be specifically selected based on an actual situation and will not be repeated herein.

Alternatively, in some embodiments, the determining candidate obstacles in the target map based on the laser point cloud data includes:
obtaining a map coordinate system of the target map;
extracting a reflection value and three-dimensional coordinates corresponding to each three-dimensional laser point from the laser point cloud data; and
determining the candidate obstacles in the target map based on the map coordinates, and the reflection value and the three-dimensional coordinates corresponding to the three-dimensional laser point.

Alternatively, in some embodiments, the determining the candidate obstacles in the target map based on the map coordinates, and the reflection value and the three-dimensional coordinates corresponding to the three-dimensional laser point includes:
determining a point cloud coordinate system corresponding to the laser point cloud data;
rendering the reflection value corresponding to the three-dimensional laser point to the target map based on the three-dimensional coordinates corresponding to the three-dimensional laser point and a transformation relationship between the map coordinate system and the point cloud coordinate system; and
determining the candidate obstacles in the target map based on a pixel value in a rendered target map.

Alternatively, in some embodiments, the rendering the reflection value corresponding to the three-dimensional laser point to the target map based on the three-dimensional coordinates corresponding to the three-dimensional laser point and a transformation relationship between the map coordinate system and the point cloud coordinate system includes:
transforming the three-dimensional coordinates corresponding to the three-dimensional laser point based on the transformation relationship between the map coordinate system and the point cloud coordinate system, to obtain map coordinates of the three-dimensional laser point in the target map; and
rendering the reflection value corresponding to the three-dimensional laser point to the target map based on the map coordinates of the three-dimensional laser point in the target map.

Alternatively, in some embodiments, the determining a target obstacle from the candidate obstacles based on the feature images includes:
inputting the feature images into a preset image classification network, to obtain classification labels of the candidate obstacles; and
determining a candidate obstacle whose classification label is a target label as the target obstacle.

Alternatively, in some embodiments, the delineating an operational area and a non-operational area in the target map based on the target obstacle includes:
obtaining at least contour information of the target obstacle below a preset height;
outputting, based on the contour information and a location of the target obstacle in the target map, an isolation curve surrounding the target obstacle; and
determining an area enclosed by the isolation curve as the non-operational area and an area other than the non-operational area as the operational area.

Alternatively, in some embodiments, after the delineating an operational area and a non-operational area in the target map based on the target obstacle, the method further includes: highlighting the operational area using a first color; and highlighting the non-operational area using a second color.

In the embodiments of the present disclosure, after the laser point cloud data in the environment corresponding to the target map is acquired, the candidate obstacles are determined in the target map based on the laser point cloud data; then, the feature images of the candidate obstacles are obtained, and the target obstacle is determined from the candidate obstacles based on the feature images; and finally, the operational area and the non-operational area are delineated in the target map based on the target obstacle. In the mowing solution provided in the present disclosure, the candidate obstacles are determined in the target map based on the laser point cloud data; then, the target obstacle is determined based on the feature images of the candidate obstacles; and finally, the operational area and the non-operational area are delineated in the target map based on the target obstacle. That is, through the combination of an image vision technology and a laser point cloud technology, the problem of delineation omission or error caused by manual delineation of the operational area and the non-operational area can be avoided. In addition, due to the unified scanning of an operation environment by the lidar, positions of all obstacles can be determined at one time without the need to delineate the obstacles one by one, thereby avoiding the problems of a low overall delineation speed and low map construction efficiency caused by the large volume of obstacles. In this way, this solution improves the operation map construction efficiency.

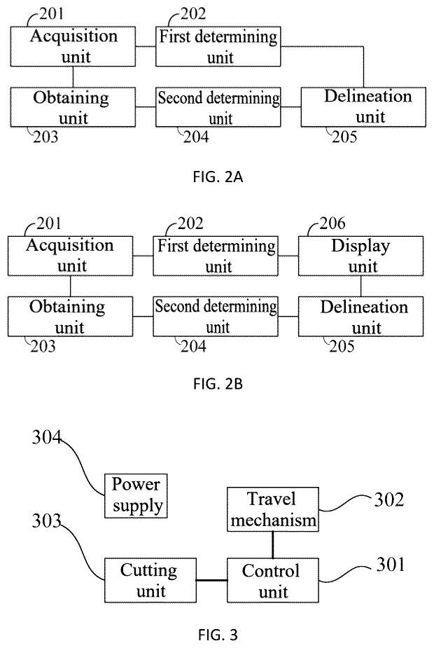

Referring to FIG. 2A, FIG. 2A is a schematic diagram of a structure of an operation map construction apparatus according to an embodiment of the present disclosure. The operation map construction apparatus may include an acquisition unit 201, a first determining unit 202, an obtaining unit 203, a second determining unit 204, and a delineation unit 205, which may be specifically as follows.

The acquisition unit 201 is configured to acquire laser point cloud data in an environment corresponding to a target map.

For example, specifically, the acquisition unit 201 may quickly establish a three-dimensional visualization model of a complex and irregular scene based on spatial point cloud data obtained by using a three-dimensional laser scanning technology.

The first determining unit 202 is configured to determine candidate obstacles in the target map based on the laser point cloud data.

Alternatively, in some embodiments, the first determining unit 202 may specifically include:
an obtaining unit configured to obtain a map coordinate system of the target map;
an extraction unit configured to extract a reflection value and three-dimensional coordinates corresponding to each three-dimensional laser point from the laser point cloud data; and
a determining unit configured to determine the candidate obstacles in the target map based on the map coordinates, and the reflection value and the three-dimensional coordinates corresponding to the three-dimensional laser point.

Alternatively, in some embodiments, the determining unit may specifically include:
a first determining subunit configured to determine a point cloud coordinate system corresponding to the laser point cloud data;
a rendering subunit configured to render the reflection value corresponding to the three-dimensional laser point to the target map based on the three-dimensional coordinates corresponding to the three-dimensional laser point and a transformation relationship between the map coordinate system and the point cloud coordinate system; and
a second determining subunit configured to determine the candidate obstacles in the target map based on a pixel value in a rendered target map.

Alternatively, in some embodiments, the rendering subunit may be specifically configured to: transform the three-dimensional coordinates corresponding to the three-dimensional laser point based on the transformation relationship between the map coordinate system and the point cloud coordinate system, to obtain map coordinates of the three-dimensional laser point in the target map; and render the reflection value corresponding to the three-dimensional laser point to the target map based on the map coordinates of the three-dimensional laser point in the target map.

The obtaining unit 203 is configured to obtain feature images of the candidate obstacles.

The second determining unit 204 is configured to determine a target obstacle from the candidate obstacles based on the feature images.

The second determining unit 204 may specifically use a convolutional neural network to determine the target obstacle from the candidate obstacles. Optionally, in some embodiments, the second determining unit 204 may be specifically configured to: input the feature images into a preset image classification network, to obtain classification labels of the candidate obstacles; and determine a candidate obstacle whose classification label is a target label as the target obstacle.

The delineation unit 205 is configured to delineate an operational area and a non-operational area in the target map based on the target obstacle.

Specifically, the delineation unit 205 may obtain contour information of the target obstacle, and delineate the operational area and the non-operational area in the target map. That is, optionally, in some embodiments, the delineation unit 205 may be specifically configured to: obtain at least the contour information of the target obstacle in the target map; output, based on the contour information and a location of the target obstacle in the target map, an isolation curve surrounding the target obstacle; and determine an area enclosed by the isolation curve as the non-operational area and an area other than the non-operational area as the operational area.

Optionally, in some embodiments, referring to FIG. 2B, the operation map construction apparatus of the present disclosure may specifically further include a display unit 206. The display unit 206 may be specifically configured to: highlight the operational area using a first color and highlight the non-operational area using a second color.

In the embodiments of the present disclosure, after the acquisition unit 201 acquires the laser point cloud data in the environment corresponding to the target map, the first determining unit 202 determines the candidate obstacles in the target map based on the laser point cloud data; then, the obtaining unit 203 obtains the feature images of the candidate obstacles, and the second determining unit 204 determines the target obstacle from the candidate obstacles based on the feature images; and finally, the delineation unit 205 delineates the operational area and the non-operational area in the target map based on the target obstacle. In the mowing solution provided in the present disclosure, the candidate obstacles are determined in the target map based on the laser point cloud data; then, the target obstacle is determined based on the feature images of the candidate obstacles; and finally, the operational area and the non-operational area are delineated in the target map based on the target obstacle. That is, through the combination of an image vision technology and a laser point cloud technology, the problem of delineation omission or error caused by manual delineation of the operational area and the non-operational area can be avoided, thereby improving the operation map construction efficiency.

In addition, an embodiment of the present disclosure further provides a mowing robot. As shown in FIG. 3, a schematic diagram of a structure of the mowing robot according to the embodiment of the present disclosure is shown. Specifically, the mowing robot may include components such as a control unit 301, a travel mechanism 302, a cutting unit 303, and a power supply 304. Those skilled in the art may understand that the structure of the electronic device shown in FIG. 3 does not impose a limitation on the electronic device, and may include more or fewer components than those shown, a combination of some components, or a different arrangement of components.

The control unit 301 is a control center of the mowing robot. The control unit 301 may specifically include components such as a central processing unit (CPU), a memory, an input/output port, a system bus, a timer/counter, a digital-to-analog converter, and an analog-to-digital converter. The CPU performs various functions of the mowing robot and processes data by running or executing software programs and/or units stored in the memory and invoking the data stored in the memory. Preferably, the CPU can integrate an application processor and a modem processor, where the application processor mainly processes operating systems and applications, etc., and the modem processor mainly processes wireless communication. It may be understood that the above mentioned modem processor may not be integrated into the CPU.

The memory may be used to store software programs and units, and the CPU executes various functional applications and processes data by running the software programs and units stored in the memory. The memory may mainly include a program storage area and a data storage area, where the program storage area can store an operating system, an application required by at least one function (such as a sound play function and an image play function), etc., and the data storage area can store data created during the use of the electronic device, etc. In addition, the memory may include a high-speed random access memory, and may also include a non-volatile memory, such as at least one disk storage device and a flash memory device, or other volatile solid-state storage devices. Accordingly, the memory may further include a memory controller to provide an access by the CPU to the memory.

The travel mechanism 302 is electrically connected to the control unit 301 for adjusting a travel speed and direction of the mowing robot in response to control signals transmitted by the control unit 301, to implement a self-moving function of the mowing robot.

The cutting unit 303 is electrically connected to the control unit 301 and is configured to adjust a height and rotation speed of a cutter disc in response to the control signals transmitted by the control unit, to implement a mowing operation.

The power supply 304 may be logically connected to the control unit 301 by means of a power management system, so as to implement functions such as charging management, discharging management, and power consumption management by means of the power management system. The power supply 304 may further include any of one or more DC or AC power supplies, a recharging system, a power failure detection circuit, a power converter or an inverter, a power status indicator, etc.

Although not shown, the mowing robot may further include a communication unit, a sensor unit, a prompt unit, etc., which will not be repeated herein.

The communication unit is configured to transmit and receive signals during transmitting and receiving information, and to enable signal transmitting and receiving between user device and a base station or a server by means of establishing a communication connection with the user device, the base station or the server.

The sensor unit is configured to acquire internal or external environmental information, and to feed the acquired environmental data back to the control unit for making a decision, thereby achieving the functions of precise positioning and intelligent obstacle avoidance of the mowing robot. Optionally, the sensor may include: an ultrasonic sensor, an infrared sensor, a collision sensor, a rain sensor, a lidar sensor, an inertial measurement unit, a tachometer, an image sensor, a position sensor and other sensors, which are not limited.

The prompt unit is configured to indicate a current operating status of the mowing robot to a user. In this solution, the prompt unit includes, but is not limited to, an indicator light, a buzzer, and the like. For example, the mowing robot can indicate to the user a current power status, an operating status of an electric motor, an operating status of the sensor, etc. by means of the indicator light. For another example, if a malfunction or theft of the mowing robot is detected, an alert can be provided by the buzzer.

Specifically, in this embodiment, the processor in the control unit 301 may load executable files corresponding to the processes of one or more applications into the memory according to the following instructions, and the processor runs the applications stored in the memory, to implement various functions as follows:
acquiring laser point cloud data in an environment corresponding to a target map; determining candidate obstacles in the target map based on the laser point cloud data; obtaining feature images of the candidate obstacles and determining a target obstacle from the candidate obstacles based on the feature images; and delineating an operational area and a non-operational area in the target map based on the target obstacle.

For the specific implementation of the above operations, refer to the foregoing embodiments, which will not be repeated herein.

In the embodiments of the present disclosure, after the laser point cloud data in the environment corresponding to the target map is acquired, the candidate obstacles are determined in the target map based on the laser point cloud data; then, the feature images of the candidate obstacles are obtained, and the target obstacle is determined from the candidate obstacles based on the feature images; and finally, the operational area and the non-operational area are delineated in the target map based on the target obstacle. In the mowing solution provided in the present disclosure, the candidate obstacles are determined in the target map based on the laser point cloud data; then, the target obstacle is determined based on the feature images of the candidate obstacles; and finally, the operational area and the non-operational area are delineated in the target map based on the target obstacle. That is, through the combination of an image vision technology and a laser point cloud technology, the problem of delineation omission or error caused by manual delineation of the operational area and the non-operational area can be avoided, thereby improving the operation map construction efficiency. In addition, due to the unified scanning of an operation environment by a lidar, positions of all obstacles can be determined at one time without the need to delineate the obstacles one by one, thereby avoiding the problems of a low overall delineation speed and low map construction efficiency caused by the large volume of obstacles.

Those of ordinary skill in the art may understand that all or some of the steps of the methods in the above embodiments may be implemented by the instructions, or be completed by controlling related hardware by means of the instructions, where the instructions may be stored in a computer-readable storage medium and loaded and executed by the processor.

Therefore, an embodiment of the present disclosure provides a storage medium storing a plurality of instructions which can be loaded by a processor to perform the steps of any of the operation map construction methods provided in the embodiments of the present disclosure. For example, the instructions may cause the following steps to be performed:
acquiring laser point cloud data in an environment corresponding to a target map; determining candidate obstacles in the target map based on the laser point cloud data; obtaining feature images of the candidate obstacles and determining a target obstacle from the candidate obstacles based on the feature images; and delineating an operational area and a non-operational area in the target map based on the target obstacle.

For the specific implementation of the above operations, refer to the foregoing embodiments, which will not be repeated herein.

The storage medium may include: a read-only memory (ROM), a random access memory (RAM), a magnetic disk or an optical disc, and the like.

Due to the instructions stored in the storage medium, the steps of any of the operation map construction methods provided in the embodiments of the present disclosure may be performed, and the beneficial effects that can be achieved by any of the operation map construction methods provided in the embodiments of the present disclosure can thus be achieved. For details, refer to the foregoing embodiments, which will not be repeated herein.

In the embodiments of the present disclosure, after the laser point cloud data in the environment corresponding to the target map is acquired, the candidate obstacles are determined in the target map based on the laser point cloud data; then, the feature images of the candidate obstacles are obtained and the target obstacle is determined from the candidate obstacles based on the feature images; and finally, the operational area and the non-operational area are delineated in the target map based on the target obstacle. In the mowing solution provided in the present disclosure, the candidate obstacles are determined in the target map based on the laser point cloud data; then, the target obstacle is determined based on the feature images of the candidate obstacles; and finally, the operational area and the non-operational area are delineated in the target map based on the target obstacle. That is, through the combination of an image vision technology and a laser point cloud technology, the problem of delineation omission or error caused by manual delineation of the operational area and the non-operational area can be avoided, thereby improving the operation map construction efficiency.

The operation map construction method and apparatus, the mowing robot, and the storage medium provided in the embodiments of the present disclosure are described in detail above. The principles and implementations of the present disclosure are set forth through specific examples herein. The descriptions of the foregoing embodiments are merely intended to facilitate understanding of the method and core ideas of the present disclosure. In addition, those skilled in the art can make variations and modifications to the present disclosure in terms of the specific implementations and application scopes according to the ideas of the present disclosure. Therefore, the content of the specification shall not be construed as a limit to the present disclosure.

1. An operational map construction method, comprising:
acquiring a laser point cloud data in an environment corresponding to a target map;
determining a candidate obstacles in the target map based on the laser point cloud data;
obtaining feature images of the candidate obstacles, and determining a target obstacle from the candidate obstacles based on the feature images of the candidate obstacles; and
delineating an operational area and a non-operational area in the target map based on the target obstacle.

2. The operational map construction method according to claim 1, wherein the determining the candidate obstacles in the target map based on the laser point cloud data comprises:
obtaining a map coordinate system of the target map;
extracting a reflection values and a three-dimensional coordinate system corresponding to each three-dimensional laser points from the laser point cloud data; and
determining the candidate obstacles in the target map based on the map coordinate system, and the reflection values and the three-dimensional coordinate systems corresponding to the three-dimensional laser points.

3. The operational map construction method according to claim 2, wherein the determining the candidate obstacles in the target map based on the map coordinates, and the reflection values and the three-dimensional coordinates corresponding to the three-dimensional laser points comprises:
determining a point cloud coordinate system corresponding to the laser point cloud data;
rendering the reflection values corresponding to the three-dimensional laser points to the target map based on the three-dimensional coordinates corresponding to the three-dimensional laser points, and a transformation relationship between the map coordinate system and the point cloud coordinate system; and
determining the candidate obstacles in the target map based on a pixel value in a rendered target map.

4. The operational map construction method according to claim 3, wherein the rendering the reflection values corresponding to the three-dimensional laser points to the target map based on the three-dimensional coordinates coordinate system corresponding to the three-dimensional laser point, and a transformation relationship between the map coordinate system and the point cloud coordinate system comprises:
transforming the three-dimensional coordinate system corresponding to the three-dimensional laser point based on the transformation relationship between the map coordinate system and the point cloud coordinate system, to obtain map coordinate system of the three-dimensional laser point in the target map; and
rendering the reflection value corresponding to the three-dimensional laser point to the target map based on the map coordinate system of the three-dimensional laser point in the target map.

5. The operational map construction method according to claim 1, wherein the determining a target obstacle from the candidate obstacles based on the feature images of the candidate obstacles comprises:
obtaining obtain classification labels of the candidate obstacles by inputting the feature images of the candidate obstacles into a preset image classification network; and
determining the candidate obstacle whose classification label is a target label as the target obstacle.

6. The operational map construction method according to claim 1, wherein the delineating an operational area and a non-operational area in the target map based on the target obstacle comprises:
obtaining at least contour information of the target obstacle below a preset height;
outputting an isolation curve that enclose the target obstacle, based on the contour information and a location of the target obstacle in the target map; and
determining an area enclosed by the isolation curve as the non-operational area and an area outside the non-operational area as the operational area.

7. The operational map construction method according to claim 1, wherein after the delineating the operational area and the non-operational area in the target map based on the target obstacle, the method further comprises:
highlighting the operational area using a first color; and
highlighting the non-operational area using a second color.

8. An operational map construction apparatus, comprising:
an acquisition unit is configured to acquire a laser point cloud data in an environment corresponding to a target map;
a first determining unit is configured to determine a candidate obstacles in the target map based on the laser point cloud data;
an obtaining unit is configured to obtain feature images of the candidate obstacles;
a second determining unit is configured to determine a target obstacle from the candidate obstacles based on the feature images of the candidate obstacles; and
a delineation module configured to delineate an operational area and a non-operational area in the target map based on the target obstacle.

9. The operational map construction apparatus according to claim 8, wherein the first determining unit is further configured to:
obtain a map coordinate system of the target map;
extract a reflection values and a three-dimensional coordinate system corresponding to each three-dimensional laser points from the laser point cloud data; and
determine the candidate obstacles in the target map based on the map coordinate system, and the reflection values and the three-dimensional coordinate system corresponding to the three-dimensional laser points.

10. The operational map construction apparatus according to claim 9, wherein the first determining unit is further configured to:
determine a point cloud coordinate system corresponding to the laser point cloud data;
render the reflection values corresponding to the three-dimensional laser points to the target map based on the three-dimensional coordinate system corresponding to the three-dimensional laser points, and a transformation relationship between the map coordinate system and the point cloud coordinate system; and
determine the candidate obstacles in the target map based on a pixel values in a rendered target map.

11. The operational map construction apparatus according to claim 8, wherein the first determining unit is further configured to:
transform the three-dimensional coordinate system corresponding to the three-dimensional laser point based on the transformation relationship between the map coordinate system and the point cloud coordinate system, to obtain map coordinate system of the three-dimensional laser point in the target map; and
render the reflection values corresponding to the three-dimensional laser points to the target map based on the map coordinate system of the three-dimensional laser point in the target map.

12. A mowing robot, comprising at least one storage medium, at least one processor, the at least one storage medium storing at least one set of instructions, the at least one processor executes the at least one set of instructions to cause the mowing robot to at least:
acquiring a laser point cloud data in an environment corresponding to a target map;
determining a candidate obstacles in the target map based on the laser point cloud data;
obtaining feature images of the candidate obstacles, and determining a target obstacle from the candidate obstacles based on the feature images of the candidate obstacles; and
delineating an operational area and a non-operational area in the target map based on the target obstacle.

13. A mowing robot according to claim 12, wherein the determining the candidate obstacles in the target map based on the laser point cloud data comprises:
obtaining a map coordinate system of the target map;
extracting a reflection values and a three-dimensional coordinate system corresponding to each three-dimensional laser points from the laser point cloud data; and
determining the candidate obstacles in the target map based on the map coordinate system, and the reflection values and the three-dimensional coordinate system corresponding to the three-dimensional laser points.

14. A mowing robot according to claim 13, wherein the determining the candidate obstacles in the target map based on the map coordinates, and the reflection values and the three-dimensional coordinate system corresponding to the three-dimensional laser points comprises:
determining a point cloud coordinate system corresponding to the laser point cloud data;
rendering the reflection values corresponding to the three-dimensional laser points to the target map based on the three-dimensional coordinate system corresponding to the three-dimensional laser point, and a transformation relationship between the map coordinate system and the point cloud coordinate system; and
determining the candidate obstacles in the target map based on a pixel values in a rendered target map.

15. The mowing robot according to claim 14, wherein the rendering the reflection value corresponding to the three-dimensional laser point to the target map based on the three-dimensional coordinates corresponding to the three-dimensional laser point, and a transformation relationship between the map coordinate system and the point cloud coordinate system comprises:
transforming the three-dimensional coordinate system corresponding to the three-dimensional laser point based on the transformation relationship between the map coordinate system and the point cloud coordinate system, to obtain map coordinate system of the three-dimensional laser points in the target map; and
rendering the reflection value corresponding to the three-dimensional laser points to the target map based on the map coordinate system of the three-dimensional laser point in the target map.

16. The mowing robot according to claim 12, wherein the determining a target obstacle from the candidate obstacles based on the feature images of the candidate obstacles comprises:
obtaining obtain classification labels of the candidate obstacles by inputting the feature images of the candidate obstacles into a preset image classification network; and
determining the candidate obstacle whose classification label is a target label as the target obstacle.

17. The mowing robot according to claim 12, wherein the delineating an operational area and a non-operational area in the target map based on the target obstacle comprises:
obtaining at least contour information of the target obstacle below a preset height;
outputting an isolation curve that enclose the target obstacle, based on the contour information and a location of the target obstacle in the target map; and
determining an area enclosed by the isolation curve as the non-operational area and an area outside the non-operational area as the operational area.

18. The mowing robot according to claim 12 wherein after the delineating the operational area and the non-operational area in the target map based on the target obstacle, the method further comprises:
highlighting the operational area using a first color; and
highlighting the non-operational area using a second color.
